(19) United States
(12) Patent Application Publication
(10) Pub. No.: US 2003/0112964 A1
(43) Pub. Date: Jun. 19, 2003

(54) Re-enterable housing for xDSL/POTS splitter

(76) Inventors: Kevin L. Morgan, Paradise, TX (US); John A. Keenum, Keller, TX (US)

Correspondence Address: CORNING CABLE SYSTEMS LLC, P O BOX 489, HICKORY, NC, 28603, US

(21) Appl. No.: 10/022,983

(22) Filed: Dec. 17, 2001

(51) Int. Cl. H04M 1/00; H04M 5/00

(52) U.S. Cl. 379/399.01; 379/325

(57) ABSTRACT

A housing is provided for interconnecting customer premises equipment with a digital subscriber line (DSL) at a location remote from a telephone company central office. The housing includes a base defining an interior cavity and at least one xDSL/POTS splitter positioned within the interior cavity. The splitter combines a POTS signal and a data signal from the central office into a combined signal on the DSL and separates a combined signal on the DSL from the customer premises equipment into the POTS signal and the data signal. In a particular embodiment, a back-plane circuit board having at least one card socket connector is positioned within the interior cavity and the splitter is mounted on a circuit card having a board edge connector. The board edge connector is received within the card socket connector to electrically connect the splitter to the back-plane circuit board.

### FIELD OF THE INVENTION

The present invention relates generally to telecommunications networks, and more particularly, to a housing for an xDSL/POTS splitter that permits a digital subscriber line (DSL) to be interconnected with customer premises equipment at a location remote from the telephone company central office.

### BACKGROUND OF THE INVENTION

It is anticipated that optical networks will someday extend higher bandwidth service, and in particular higher bandwidth access to the Internet, all the way from the telephone company central office to the home. At present, however, such all-optical networks are not generally available, especially in the segment of the network known as the “last mile.” Accordingly, telecommunications service providers are currently developing digital subscriber line (DSL) networks to meet the demand for higher-bandwidth access to the Internet over existing copper telephone lines. Several DSL technologies are presently available or in development, including for example, HDSL, IDSL, SDSL, VDSL, RADSL, and ADSL. The various DSL technologies are collectively referred to herein generically as “xDSL.” Asymmetric DSL (ADSL) is particularly suited for access to the Internet because the majority of transmissions travel downstream to Internet users and upstream bandwidth can be reduced in favor of increased downstream bandwidth. With upstream bandwidth reduced, ADSL can provide downstream bandwidth up to about 8 Mbps. Another advantage of xDSL technologies is that many, including ADSL, can simultaneously carry lower frequency voice signals and higher frequency data signals over the same telephone line. The voice signals, referred to herein as Plain Old Telephone Service (POTS) signals, are typically transmitted over a frequency band from about 100 Hz to about 4 kHz. As a result, conventional customer premises equipment, such as standard telephones, answering machines, facsimile machines and analog modems, can be used to transmit and receive POTS signals over an ADSL line. ADSL data signals, on the other hand, are typically transmitted upstream over a frequency band from about 85 kHz to about 95 kHz, and are typically received downstream over a frequency band from about 100 MHz to about 500 MHz. As a result, higher frequency customer premises equipment, such as computers and digital modems, are required to transmit and receive data signals over an ADSL line.

Because xDSL technologies utilize lower frequency bands for POTS signals and higher frequency bands for data signals, splitters must be employed at some point in the telephone line between the telephone company central office and the customer premises. In the past, a first analog or digital splitter has been utilized at the central office to combine the POTS signal and the data signal into a combined signal over an ADSL line. A second analog or digital splitter is provided at the customer premises to separate the combined signal into the POTS signal for conventional customer premises equipment and the data signal for higher frequency customer premises equipment. Typically, the lower frequency POTS signal is filtered from the combined signal at both the first and the second splitter using a low-pass filter. The higher frequency data signal may also be filtered from the combined signal at one or both of the first and second splitters using a high-pass filter. The filtered voice signal and/or the filtered data signal may then be passed upstream of the first (i.e., central office) splitter through an analog to digital converter. The filtered and converted voice signal is preferably transmitted by a conventional telephone switch over a digital pulse code modulated (PCM) highway in a known manner. Similarly, the filtered and converted data signal is preferably transmitted over a high speed, high bandwidth, digital data highway, for example a T1 line, in a known manner.

The most significant disadvantage of xDSL technologies, and in particular ADSL technology, is that transmission over existing copper telephone lines is limited in range to about 18,000 feet from the telephone company central office due to line losses. Thus, a significant number of the homes and businesses demanding ADSL service are not within the desired range of the telephone company central office for optimal performance. Most, if not all, telecommunications networks, however, already utilize termination equipment to interconnect conventional customer premises equipment with a POTS line at a location remote from the telephone company central office. The POTS line termination equipment is typically housed in a telecommunications enclosure, such as an above-ground pedestal or an aerial, pole-mounted or buried closure. The POTS line termination equipment includes connectors, for example conventional screw terminals or insulation displacement contact (IDC) terminals, that interconnect a copper wire pair from the customer premises equipment with a copper wire pair from the telephone company main distribution cable. It would be advantageous to likewise interconnect higher frequency customer premises equipment with an ADSL line at a location remote from the telephone company central office, thereby providing DSL service, such as higher speed Internet access, to customers that are located more than about 18,000 feet from a telephone company central office. The present invention addresses this need by providing a housing for an xDSL/POTS splitter that permits a digital subscriber line (DSL) to be interconnected with customer premises equipment at a location remote from the telephone company central office.

### BRIEF DESCRIPTION OF THE DRAWINGS

The present invention will be described in conjunction with the accompanying drawings in which like reference numerals represent the same or similar parts in the various views. The drawings, which are incorporated in and constitute a part of this specification, provide further understanding of the invention, illustrate various embodiments of the invention, and, together with the description, fully explain the principles and objectives thereof. More specifically:

FIG. 1 is a perspective view of a re-enterable housing according to the invention affixed to a telecommunications enclosure at a location remote from a telephone company central office;

FIG. 2 is a detail perspective view of the re-enterable housing of FIG. 1 shown with the cover in the opened position;

FIG. 3 is a detail plan view of the re-enterable housing of FIG. 2; and

FIG. 4 is a schematic diagram illustrating the direction of transmission of the POTS signal, the data signal and the combined signal between the re-enterable housing of FIG. 1 and the telecommunications enclosure.

### DETAILED DESCRIPTION OF EMBODIMENTS OF THE INVENTION

The present invention is described more fully hereinafter with reference to the accompanying drawings, in which embodiments of the invention are shown. The invention may, however, be embodied in many different forms, and therefore, should not be construed as being limited to the embodiments described and shown herein. Illustrative embodiments are set forth herein so that this description will be thorough and complete, and will fully convey the intended scope of the invention, while enabling those skilled in the art to make and practice the invention without undue experimentation.

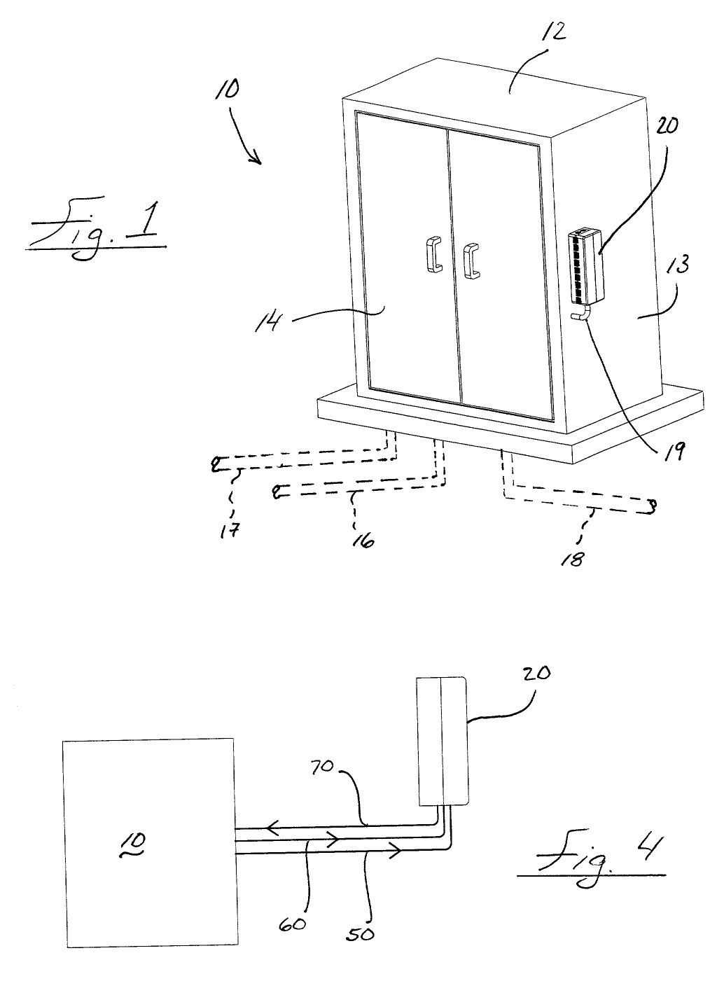

Referring now to FIG. 1, a telecommunications enclosure, and in particular an above-ground pedestal 10, houses termination equipment for interconnecting conventional customer premises equipment, such as a standard telephone, facsimile machine or analog modem, with a Plain Old Telephone Service (POTS) line from the telephone company central office. The POTS line comprises a main POTS distribution cable 16 that is buried underground and enters the pedestal 10 from underneath the cabinet 12. In the particular embodiment shown and described herein, the pedestal 10 further houses termination equipment for interconnecting higher frequency customer premises equipment, such as a computer or digital modem, with a data line from the telephone company central office or another source, for example an Internet Service Provider (ISP). The data line comprises a main data distribution cable 17 that likewise is buried underground and enters the pedestal 10 from underneath the cabinet 12. The POTS distribution cable 16 and the data distribution cable 17 each comprise a plurality of copper wire pairs, referred to in the art as “twisted pairs.” At least some of the wire pairs of the POTS distribution cable 16 and the data distribution cable 17 are interconnected with wire pairs from the customer premises equipment that are routed to the pedestal 10 through one or more drop cables 18. The remainder of the wire pairs of the POTS distribution cable 16 and the data distribution cable 17 may be routed out of the pedestal 10 along the POTS line and the data line to yet another pedestal in the telecommunications network located remote from the telephone company central office. The pedestal 10 provides a convenient access point in the telecommunications network for a field technician from the telephone company to initially install and subsequently reconfigure the connections between the drop cables 18 and the POTS distribution cable 16 and the data distribution cable 17. The particular pedestal 10 shown in FIG. 1 provides POTS and higher frequency data service to customers of the telephone company, such as homes and businesses, that are located more than about 18,000 feet from the central office. Although an above-ground pedestal is shown and described, the telecommunications enclosure may also be an aerial, pole-mounted or buried closure, or any other enclosure in a telecommunications network at a location remote from a telephone company central office.

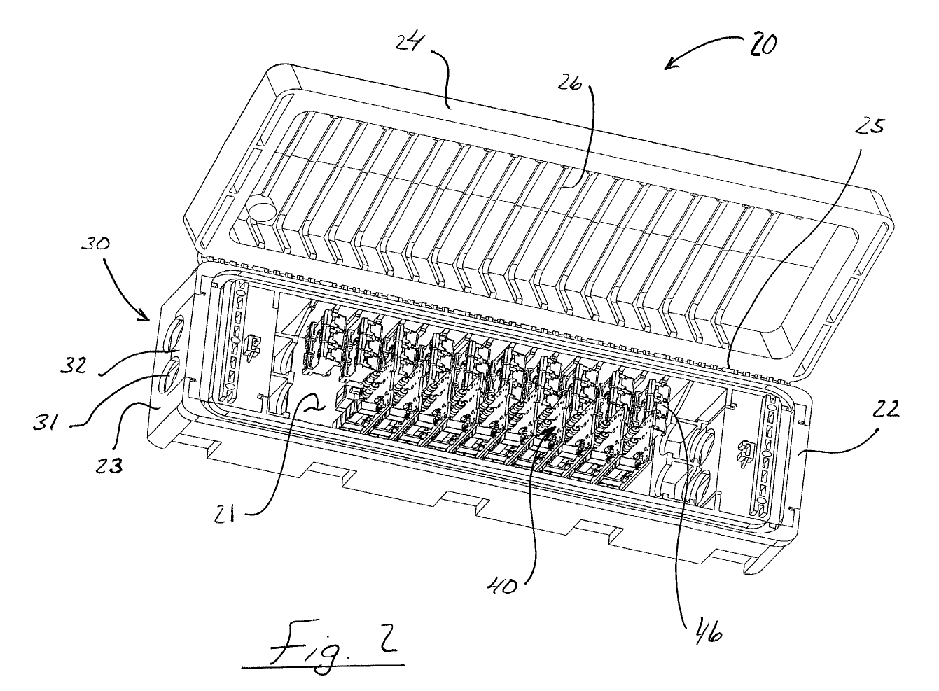

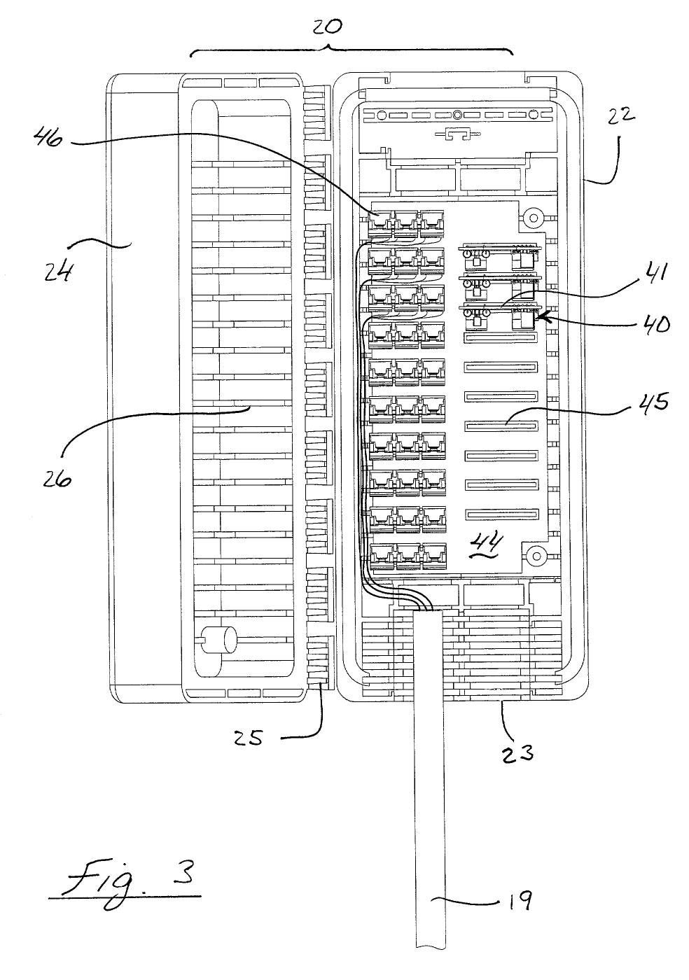

A housing 20, constructed in accordance with the invention is also shown in FIG. 1. The housing 20 is operatively coupled to the telecommunications enclosure as will be described hereinafter. As shown in FIGS. 2 and 3, housing 20 comprises a base 22 and a cover 24 each made of a lightweight, yet rigid material, such as aluminum, plastic or thermoplastic. The cover 24 is movably attached to the base 22 such that the cover may be opened and closed on the base. Accordingly, the housing is re-enterable for a purpose to be described. As shown, the base 22 is affixed to the exterior surface of one of the side walls 13 of the cabinet 12. The base 22, however, may be affixed at any convenient location on the exterior of the cabinet 12, or may be affixed at any convenient location on the interior of the cabinet 12. If located on the interior of the cabinet 12, the housing 20 is accessed through doors 14, which are typically secured by a lock mechanism that can only be opened by authorized personnel, such as a field technician, dispatched from the telephone company. Furthermore, the cover 24 may be affixed to the cabinet 12 instead of the base 22 and the base may be adapted to be opened and closed on the cover. Regardless, the base 22 and the cover 24 are positioned relative to the pedestal 10 such that the housing 20 is operatively coupled to the telecommunications enclosure located remote from the telephone company central office. As such, the housing 20 may be provided with brackets or straps (not shown) for securing the base 22 (or cover 24) to the pedestal 10, a telephone pole, building or other structure, or may be provided with hangars for suspending the housing 20 from an aerial cable strand in a known manner. Although the housing 20 depicted in the exemplary embodiment is shown as an in-line type housing, it may be configured in any known manner, such as a canister or “butt” type housing, without departing from the intended spirit or scope of the invention.

As shown herein, the base 22 is generally box-shaped and defines an interior cavity 21 for housing telecommunications hardware, such as routing, signal processing and terminating equipment. The base 22 may have any of a variety of shapes, such as square, circular, oval or elliptical, that is suitable for housing telecommunications hardware and for interconnecting wire pairs from one or more drop cables 18 with wire pairs from the POTS distribution cable 16 and the data distribution cable 17. As shown and described herein, the base 22 is generally rectangular in the lengthwise and widthwise dimensions and is elongated in the lengthwise dimension (relative to the widthwise dimension) between a pair of opposed, closed ends 23. Preferably, the depth dimension is substantially less than either the lengthwise dimension or the widthwise dimension to optimize access to the routing, signal processing and terminating equipment at any location within the interior cavity 21 of the base 22. As previously mentioned, the cover 24 is attached to the base 22 and adapted to be opened and closed thereon. As shown, the cover 24 is generally rectangular and is hingedly affixed to the base 22 along an upper edge of one of the side walls by a continuous hinge 25. Preferably, the hinge 25 is a mechanical hinge. However, the hinge 25 may also be formed as a living hinge when the base 22 and the cover 24 are integrally molded from a plastic material. In another embodiment, the cover 24 may be slidably attached to the base 22 to expose selected portions of the interior cavity 21 of the base 22. Alternatively, the entire cover 24, or only a portion of the cover 24, may be removably attached to the base 22 to provide unobstructed access to the interior cavity 21. The base 22 or the cover 24 is preferably provided with clasps (not shown) or other conventional means for securing the cover 24 to the base 22 in the closed configuration. The base 22 or the cover 24 may also be provided with conventional means for retaining the cover 24 in the opened configuration. If necessary, the cover 24 may be provided with lengthwise or widthwise stiffening ribs 26 to strengthen and prevent distortion of the cover 24.

The housing 20 is shown in FIGS. 2 and 3 with the cover 24 hingedly affixed to the base 22 and opened thereon. At least one, and preferably a plurality, of wire port assemblies 30 are provided on the opposed end walls 23 of the base 22. In the embodiment illustrated in FIG. 1, the housing 20 is mounted in any suitable manner on a telecommunications enclosure (e.g., above ground pedestal 10) at a location remote from the telephone company central office. An opening is formed through a side wall 13 of the cabinet 12 of the pedestal 10 for receiving a conduit 19. Conduit 19 is routed from the interior of the pedestal 10 through the opening in the side wall 13 to one of the wire port assemblies 30 in an end wall 23 of the housing 20. The conduit 19 provides a “wire-way” for gathering and routing wire pairs from the interior of the telecommunications enclosure (e.g., pedestal 10) to the interior cavity 21 defined by the base 22. Typically, a portion of the sheath of the POTS distribution cable 16 and the data distribution cable 17 is removed so that the wire pairs are exposed within the interior of the pedestal 10. At least one of the wire pairs of the POTS distribution cable 16 and at least one of the wire pairs of the data distribution cable 17 are gathered and routed through the conduit 19 into the interior cavity 21 defined by the base 22 for a purpose to be described hereinafter. The remainder of the wire pairs of the POTS distribution cable 16 and the wire pairs of the data distribution cable 17 are interconnected with wire pairs of one or more drop cables 18, or continue uninterrupted through the interior of the pedestal 10 and back into the distribution cables 16, 17 to provide telecommunications service at another location in the network remote from the telephone company central office. The latter instance described above will be readily recognized by those skilled in the art as a “taut sheath” application.

In the embodiment illustrated, the conduit 19 is routed through the wire port assembly 30 formed in the lower end wall 23 of the base 22. The wire port assembly 30 located in the end wall 23 typically receives only one conduit 19, but may receive two conduits 19; one containing wire pairs of the POTS distribution cable 16 and one containing wire pairs of the data distribution cable 17. A third conduit 19 may also be received by a wire port assembly 30 in either end wall 23 of base 22 to gather and route wire pairs that carry a combined signal comprising the POTS signal and the data signal, as will be described hereinafter. As shown herein, one of the ports 31 of the wire port assembly 30 in end wall 23 is not utilized and a single conduit 19 containing one or more wire pairs of the POTS distribution cable 16, the data distribution cable 17 and the combined POTS and data signal is received within the other port. However, multiple conduits 19 may be received within one or more ports of either wire port assembly 30 to gather and route the wire pairs into the housing 20 as required for a particular application. Furthermore, one or more additional conduits 19 may be positioned within an unused port 31 of either wire port assembly 30 at a later time to expand the service capacity of the housing 20. Each wire port assembly 30 has at least one, and preferably a plurality of semi-circular recesses formed in base 22 and a corresponding plurality of semi-circular recesses formed in cap 32. Cap 32 is shown in FIG. 2, but is shown removed in FIG. 3 for purposes of clarity. One or more conduits 19 are received within the semi-circular recesses formed in the base 22. The cap 32 engages the base 22 such that the semi-circular recesses of the cap 32 are aligned with the semi-circular recesses of the base 22 and each conduit 19 is retained in a sealed manner between the base 22 and the cap 32. As shown, each wire port assembly 30 has two semi-circular recesses formed in base 22 and cap 32 that permit additional conduits 19 to be installed into the housing 20 without disturbing any conduit 19 previously installed. If less than four conduits 19 are disposed between the base 22 and the cap 33, any empty recesses may be fitted with a sealing plug (not shown) so that the housing 20 is thereby sealed and remains substantially rainproof.

The interior cavity 21 defined by the base 22 of the housing 20 contains passive electronics for combining the POTS signal on the POTS line with the data signal on the data line, and for separating the POTS signal or the data signal from the combined signal onto the POTS line or the data line, respectively. The POTS signal and the data signal are combined and separated so that customers of the telecommunications network located more than 18,000 feet from the telephone company central office can transmit and receive higher frequency communications, for example high speed Internet access, over a single telephone line, for example a digital subscriber line (DSL). Combining and separating the signals at a telecommunications enclosure, such as pedestal 10, located remote from the telephone company central office reduces the inherent losses in the combined signal transmitted and received over the DSL. The passive electronics do not require external power. As a result, the POTS signal remains available for emergency voice communications on the DSL in the event of an electrical power outage between the customer premises and the telephone company central office. In the embodiment shown and described herein, the passive electronics comprise at least one xDSL/POTS splitter 40 positioned within the interior cavity 21 defined by the base 22. The passive electronics may further comprise a back-plane circuit board 44 and at least one wire connector 46, as will be described hereinafter.

As illustrated schematically in FIG. 4, the xDSL/POTS splitter 40 combines a POTS signal 50 on the POTS line and a data signal 60 on the data line into a combined signal 70 on a DSL for communications between the telephone company central office and the customer premises equipment. Similarly, the xDSL/POTS splitter 40 separates the combined signal 70 on the DSL into a POTS signal 50 on the POTS line and a data signal 60 on the data line for communications from the customer premises equipment to the telephone company central office. The xDSL/POTS splitter 40 may be any suitable means for combining and separating the POTS and data signals. For purposes of example only and not by way of limitation, the xDSL/POTS splitter 40 may be an electrical circuit comprising a low-pass filter for separating the POTS signal 50 from the combined signal 70 for communications from the customer premises equipment to the central office. Obviously, the low-pass filter will also pass the POTS signal 50 to be combined with the data signal 60 into the combined signal 70 for communications from the central office to the customer premises equipment. Alternatively, the xDSL/POTS splitter 40 may comprise a high-pass filter for separating the data signal 60 from the combined signal 70 for communications in the direction of the central office. Obviously, the high-pass filter will also pass the data signal 60 to be combined with the POTS signal 50 into the combined signal 70 for communications in the direction of the customer premises equipment. Of course, the xDSL/POTS splitter 40 may comprise both a low-pass filter and a high-pass filter that separate the POTS signal 50 and the data signal 60 from the combined signal 70 and combine the POTS signal 50 and the data signal 60 into the combined signal 70, in a manner well known and understood in the art.

The xDSL/POTS splitter 40 may be mounted on a conventional circuit card 41 having a board edge connector (not shown) and the passive electronics may further comprise a back-plane circuit board 44 disposed within the interior cavity 21 defined by the base 22. The back-plane circuit board 44 has at least one card socket connector 45 (FIG. 3) for receiving the board edge connector of the circuit card 41 so that the xDSL/POTS splitter 40 is in electrical communication with the back-plane circuit board 44. As shown, the back-plane circuit board 44 has 10 socket connectors 45, 3 of which have circuit cards 41 (each having an xDSL splitter 40) installed therein. Typically, each circuit card provides DSL service to a separate drop cable 18. Thus, the remaining socket connectors 45 are available for future expansion of the housing 20 to service additional drop cables 18. As previously mentioned, the POTS signal 50 is carried by a plurality of wire pairs of the POTS distribution cable 16 and the data signal 60 is carried by a plurality of wire pairs of the data distribution cable 17. Similarly, the combined signal 70 is carried by a plurality of wire pairs of the one or more drop cables 18 routed between the xDSL/POTS splitter 40 and the customer premises equipment. The wire pairs for the POTS signal 50, the wire pairs for the data signal 60 and the wire pairs for the combined signal 70 may be terminated directly on the circuit card 41, for example by soldering to wire terminations. The POTS signal 50 and the data signal 60 are then combined or the combined signal 70 is then separated by the xDSL/POTS splitter 40 as previously described. Alternatively, the passive electronics may further comprise at least one wire connector 46 disposed within the interior cavity 21 defined by the base 22 for interconnecting the wire pairs for the POTS signal 50 and the wire pairs for the data signal 60 with the wire pairs for the combined signal 70. The wire connector 46 comprises a plurality of terminals, for example screw terminals or insulation displacement contact (IDC) terminals, that electrically connect the wire pairs to a socket connector 45 on the back-plane circuit board 44. For example, the screw terminals or IDC terminals may be electrically connected to the socket connector 45 through circuit lands provided on the back-plane circuit board 44 to route the signals 50, 60, 70 between the wire connector 46 and the xDSL/POTS splitter 40 on the circuit card 41 received within the socket connector 45. Accordingly, the xDSL/POTS splitter 40 becomes active when the circuit card 41 is installed into the socket connector 45 and the appropriate wire pairs are connected to the corresponding terminals on the wire connector 46. As a result, the combined signal 70 is carried on the DSL comprising drop cable 18 between the telephone company central office and the customer premises equipment. The combined signal 70 is separated again into the POTS signal 50 and the data signal 60 at the customer premises in a known manner as required for use with conventional customer premises equipment and higher frequency customer premises equipment. The configuration and operation of the splitter at the customer premises is well known and understood by those skilled in the art, and thus, forms no part of the present invention.

The illustrative embodiments of a re-enterable housing for an xDSL/POS splitter operatively coupled with a telecommunications enclosure at a location remote from a telephone company central office as shown and described herein provides a number of significant advantages. In particular, a housing according to the invention permits a digital subscriber line (DSL) to be interconnected with customer premises equipment at a location remote from the telephone company central office. Accordingly, DSL service, such as higher speed Internet access, may be provided to customers that are located more than about 18,000 feet from a telephone company central office. The housing may be affixed to the exterior of the telecommunications enclosure or, if space permits, may be affixed to the interior of the telecommunications enclosure. The housing permits a sufficient number of xDSL/POTS splitters to be installed to meet the initial demand for DSL service, yet the housing is re-enterable to also permit a filed technician to subsequently reconfigure the housing with additional xDSL/POTS splitters and thereby expand service to additional customer premises. The wire pairs of the POTS line, the data line and the DSL may be terminated directly to the xDSL/POTS splitter, or may be terminated to at least one wire connector that is electrically connected to the xDSL/POTS splitter through a back-plane circuit board. The wire connector may comprise conventional screw terminals or IDC terminals.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed herein and that further modifications and other embodiments are intended to be included within the scope of the appended claims. Although specific terms are employed herein, they are used in a generic and descriptive sense only and not for purposes of limitation.

That which is claimed is:

1. An apparatus for interconnecting customer premises equipment with a digital subscriber line (DSL) at a location remote from a telephone company central office, the apparatus comprising
a housing comprising
a base defining an interior cavity and adapted to be operatively coupled with a telecommunications enclosure at the location remote from the telephone company central office; and
a cover movably attached to the base and adapted to be opened and closed thereon; and
at least one xDSL/POTS splitter positioned within the interior cavity defined by the base, the xDSL/POTS splitter combining a POTS signal and a data signal from the telephone company central office into a combined signal on the DSL and separating the combined signal on the DSL from the customer premises equipment into the POTS signal and the data signal.

2. The apparatus according to claim 1 wherein the xDSL/POTS splitter is provided on a circuit card having a board edge connector and wherein the apparatus further comprises a back-plane circuit board positioned within the interior cavity defined by the base and having at least one card socket connector for receiving the board edge connector of the circuit card so that the xDSL/POTS splitter is in electrical communication with the back-plane circuit board.

3. The apparatus according to claim 2 further comprising at least one wire connector positioned within the interior cavity defined by the base and electrically connected to the back-plane circuit board so that the wire connector is in electrical communication with the xDSL/POTS splitter through the back-plane circuit board.

4. The apparatus according to claim 3 wherein the at least one wire connector is selected from the group consisting of a screw terminal and an insulation displacement contact (IDC) terminal.

5. The apparatus according to claim 1 wherein the base has at least one opening formed therethrough for receiving a conduit connecting the housing to the telecommunications enclosure at the location remote from the telephone company central office.

6. The apparatus according to claim 5 wherein the POTS signal is provided on a first telephone line from the telephone company central office and the data signal is provided on a second telephone line from the telephone company central office and wherein the conduit provides a wire-way for routing the DSL, the first telephone line, and the second telephone line between the telecommunications enclosure and the housing.

7. The apparatus according to claim 5 wherein the conduit sealingly engages the base and wherein the cover is hingedly attached to and sealingly engages the base such that the housing is substantially rainproof when the cover is closed on the base.

8. The apparatus according to claim 1 wherein the xDSL/POTS splitter comprises at least one of a low-pass filter for passing the POTS signal and a high-pass filter for passing the data signal.

9. A housing for interconnecting customer premises equipment with a digital subscriber line (DSL) at a location remote from a telephone company central office, the housing comprising
a base defining an interior cavity;
a cover movably attached to the base and adapted to be opened and closed thereon; and
at least one xDSL/POTS splitter positioned within the interior cavity defined by the base, the xDSL/POTS splitter combining a POTS signal and a data signal from the telephone company central office into a combined signal on the DSL and separating the combined signal on the DSL from the customer premises equipment into the POTS signal and the data signal.

10. The housing according to claim 9 wherein the xDSL/POTS splitter is provided on a circuit card having a board edge connector and wherein the apparatus further comprises a back-plane circuit board positioned within the interior cavity defined by the base and having at least one card socket connector for receiving the board edge connector of the circuit card so that the xDSL/POTS splitter is in electrical communication with the back-plane circuit board.

11. The apparatus according to claim 10 further comprising at least one wire connector positioned within the interior cavity defined by the base and electrically connected to the back-plane circuit board so that the wire connector is in electrical communication with the xDSL/POTS splitter through the back-plane circuit board.

12. The apparatus according to claim 11 wherein the at least one wire connector is selected from the group consisting of a screw terminal and an insulation displacement contact (IDC) terminal.

13. The apparatus according to claim 9 wherein the base has at least one opening formed therethrough for receiving a conduit connecting the housing to a telecommunications enclosure at the location remote from the telephone company central office.

14. The apparatus according to claim 13 wherein the POTS signal is provided on a first telephone line from the telephone company central office and the data signal is provided on a second telephone line from the telephone company central office and wherein the conduit provides a wire-way for routing the DSL, the first telephone line, and the second telephone line between the telecommunications enclosure and the housing.

15. The apparatus according to claim 13 wherein the conduit sealingly engages the base and wherein the cover is hingedly attached to and sealingly engages the base such that the housing is substantially rainproof when the cover is closed on the base.

16. The apparatus according to claim 9 wherein the xDSL/POTS splitter comprises at least one of a low-pass filter for passing the POTS signal and a high-pass filter for passing the data signal.

17. A method for interconnecting customer premises equipment with a digital subscriber line (DSL) at a location remote from a telephone company central office, the method comprising
providing an xDSL/POTS splitter at the location remote from the telephone company central office;
routing a first telephone line comprising a POTS signal to the xDSL/POTS splitter;
routing a second telephone line comprising a data signal to the xDSL/POTS splitter;
combining the POTS signal and the data signal using the xDSL/POTS splitter to create a combined signal on the DSL comprising the POTS signal and the data signal; and
routing the DSL between the xDSL/POTS splitter and the customer premises equipment.

18. The method according to claim 17 comprising the further steps of
providing a housing, the xDSL/POTS splitter disposed within the housing; and
operatively coupling the housing to a telecommunications enclosure at the location remote from the telephone company central office.

19. The method according to claim 18 comprising the further steps of
providing a back-plane circuit board disposed within the housing; and
electrically connecting the xDSL/POTS splitter to the back-plane circuit board.

20. The method according to claim 19 comprising the further steps of
providing at least one wire connector disposed within the housing; and
electrically connecting the at least one wire connector to the back-plane circuit board so that the at least one wire connector is electrically connected to the xDSL/POTS splitter through the back-plane circuit board.
